(19) United States
(12) Patent Application Publication
(10) Pub. No.: US 2009/0152782 A1
(43) Pub. Date: Jun. 18, 2009

(54) USER INTERFACE WITH CONTROLLABLE DUAL SPRING RATE RETURN TO NULL CANTILEVER SPRINGS

(75) Inventors: Keith D. Larson, Petoskey, MI (US); Joseph M. Walling, Boyne City, MI (US)

Correspondence Address: HONEYWELL INTERNATIONAL INC., 101 COLUMBIA ROAD, P O BOX 2245, MORRISTOWN, NJ, 07962-2245, US

(73) Assignee: HONEYWELL INTERNATIONAL, INC., Morristown, NJ (US)

(21) Appl. No.: 11/957,607

(22) Filed: Dec. 17, 2007

(51) Int. Cl. F16F 1/20

(52) U.S. Cl. 267/158

(57) ABSTRACT

A spring-return-to-null assembly, which may be used with various types of hand controllers or other human-machine interfaces, includes a cantilever spring and a pivot assembly. The cantilever spring is adapted to be coupled to a shaft and is configured to supply a torque thereto. The pivot assembly engages the cantilever spring and is configurable to exhibit either equal or dual spring rates, depending on the direction in which the torque is supplied to the shaft.

### TECHNICAL FIELD

The present invention generally relates to devices that are spring biased to a null position and, more particularly, to a cantilever spring return to null assembly that provides controllable dual spring rates.

### BACKGROUND

Human-machine interfaces that are used to translate human movements to machine movements are used in myriad industries. For example, some aircraft flight control systems include a human-machine interface in the form of one or more hand or foot user interfaces. The user interfaces are typically configured to be disposed in a null position and the flight control system, in response to input forces supplied to the user interface from the pilot that move the user interface from its null position, controls the movements of various aircraft flight control surfaces. No matter the particular end-use system, the human-machine interface preferably includes some type of haptic feedback mechanism back through the interface to the interface operator. These haptic feedback mechanisms may be implemented using active devices, passive devices, or both.

Passive devices are generally implemented using one or more springs that not only supply haptic feedback, but also supply forces that urge the user interface, when moved from the null position, back toward the null position. Moreover, in some implementations, it may be desired to supply different force magnitudes to the user interface depending on the direction in which the user interface is being moved. For example, it may be desirable to supply a greater force magnitude when the user interface is being moved in one direction than when it is being moved in another direction. In the context of the above-mentioned aircraft user interfaces, it may be desirable to supply a greater force magnitude when the user interface is being moved in an inboard direction than when it is being moved in an outboard direction.

In some instances, one or more cantilever springs may be used to implement passive, return-to-null devices. In such instances, the cantilever spring may be coupled at one end to a rotating shaft. One drawback with using this type of spring is that cantilever springs, when rotated from a shaft with a fixed pivot point, are inherently non-linear. This is due, at least in part, to the spring length varying as the angular displacement of the shaft varies from its null position. More specifically, the spring rate of the cantilever springs decreases as the angular displacement from the null position increases. Another drawback with this type of spring is that plural cantilever springs may be needed to exhibit the desired variations in force magnitudes for different user interface movement directions.

Hence, there is a need for a passive return-to-null device, such as a cantilever spring, that exhibits little, if any, spring rate non-linearity its fixed pivot point is rotated from a null position, and/or that may be configured to exhibit variations in force magnitudes for different user interface movement directions. The present invention addresses at least these needs.

### BRIEF SUMMARY

In one embodiment, and by way of example only, a return-to-null assembly includes a shaft, a cantilever spring, and a pivot assembly. The shaft is configured to rotate from a null position to a plurality of control positions. The cantilever spring includes a fixed end, a free end, and opposing first and second sides. The cantilever spring fixed end is coupled to the shaft and is configured to supply a torque to the shaft, at least when the shaft is rotated from the null position, that urges the shaft toward the null position. The pivot assembly engages the cantilever spring at a location that is closer to the cantilever spring free end than the cantilever spring fixed end, and includes a first contact, a second contact, a first load spring, and a second load spring. The first contact engages the cantilever spring first side, the second contact engages the cantilever spring second side, the first load spring supplies a first force to the first contact that urges the first contact into engagement with the cantilever spring first side, and the second load spring supplies a second force to the second contact that urges the second contact into engagement with the cantilever spring second side.

In another exemplary embodiment, a spring-return-to-null assembly includes a cantilever spring and a pivot assembly. The cantilever spring includes a fixed end, a free end, and opposing first and second sides. The cantilever spring fixed end is adapted to be coupled to a shaft and is configured to supply a torque to the shaft at least when a torque is supplied to the cantilever spring fixed end. The pivot assembly engages the cantilever spring at a location that is closer to the cantilever spring free end than the cantilever spring fixed end, and includes a first contact, a second contact, a first load spring, and a second load spring. The first contact engages the cantilever spring first side, the second contact engages the cantilever spring second side, the first load spring supplies a force to the first contact that urges the first contact into engagement with the cantilever spring first side, and the second load spring supplies a force to the second contact that urges the second contact into engagement with the cantilever spring second side.

In yet another exemplary embodiment, a spring pivot assembly includes a frame and a pair of spring-loaded roller assemblies. The pair of spring-loaded roller assemblies are movably disposed within the frame, and each includes a bracket, a roller shaft, a roller, a plurality of bearings, and a load spring. The bracket is movably disposed within the frame, the roller shaft is coupled to the bracket, and the roller surrounds at least a portion of the roller shaft. Each bearing includes an inner race and an outer race, and each of the inner races is mounted on the roller shaft, and the roller is mounted on each of the outer races. The load spring is disposed between the frame and the bracket.

In still exemplary embodiment, a hand controller assembly includes a user interface and a cantilever spring. The user interface is configured to rotate from a null position to a plurality of control positions. The cantilever spring assembly is coupled to the user interface and is configured to supply a force to the user interface, at least when the user interface is rotated from the null position, that urges the user interface toward the null position. The cantilever spring assembly comprises a plurality of individual cantilever springs stacked in parallel. Each individual cantilever spring is in sliding contact with at least one other individual cantilever spring. Each individual cantilever spring includes a fixed end and a free end, and the fixed end of each individual cantilever spring is coupled to the user interface.

Furthermore, other desirable features and characteristics of the present invention will become apparent from the subsequent detailed description of the invention and the appended claims, taken in conjunction with the accompanying drawings and this background of the invention.

### BRIEF DESCRIPTION OF THE DRAWINGS

The present invention will hereinafter be described in conjunction with the following drawing figures, wherein like numerals denote like elements, and

FIG. 1 is a perspective view of an exemplary embodiment of a portion of a human-machine interface assembly;

FIG. 2 is a front view of an exemplary spring return-to-null assembly that may be used to implement the human-machine interface of FIG. 1;

FIGS. 3A and 3B depict an exemplary cantilever spring that may be used to implement the spring return-to-null assembly of FIG. 2

FIG. 4 is a plan view of an exemplary pivot assembly that may be used to implement the spring return-to-null assembly of FIG. 2; and

FIG. 5 is an exploded view of the exemplary pivot assembly depicted in FIG. 4;

FIG. 6 is a front view of the exemplary pivot assembly depicted in FIG. 4;

FIG. 7 is a top view of the exemplary pivot assembly depicted in FIG. 4;

FIGS. 8 and 9 are cross section views of the exemplary pivot assembly depicted in FIG. 4 taken along lines 8-8 and 9-9 in FIG. 7, respectively;

FIGS. 10 and 11 depict operation of the spring return-to-null assembly when mounted as depicted in FIG. 2;

FIGS. 12 and 13 depict an alternative mounting arrangement of the spring return-to-null assembly to implement dual spring rates; and

FIGS. 14-17 depict operation of the spring return-to-null assembly when mounted as depicted in FIGS. 12 and 13.

### DETAILED DESCRIPTION

The following detailed description is merely exemplary in nature and is not intended to limit the invention or the application and uses of the invention. Furthermore, there is no intention to be bound by any theory presented in the preceding background or the following detailed description.

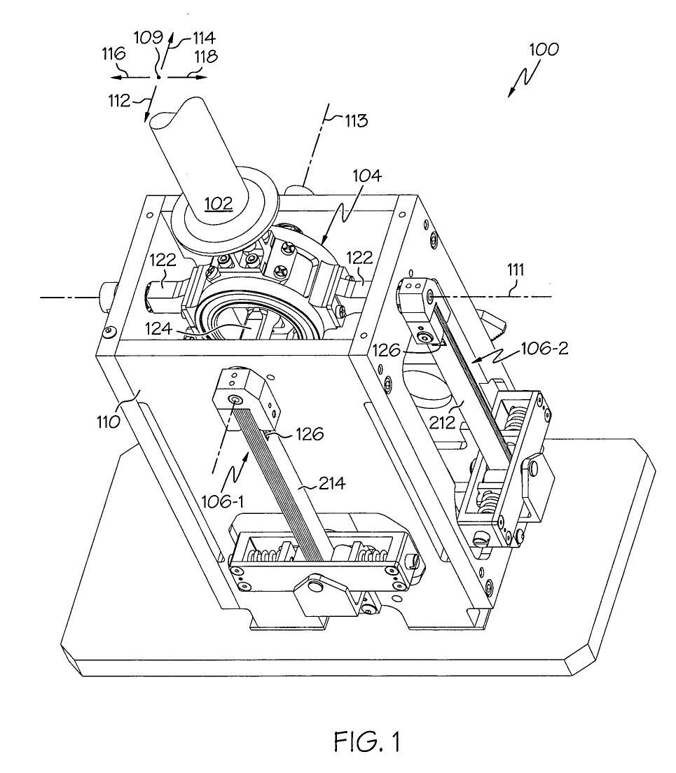

An exemplary embodiment of a portion of a human-machine interface assembly 100 is depicted in FIG. 1, and includes a user interface 102, a gimbal assembly 104, and a plurality of spring return-to-null assemblies 106. The user interface 102 is coupled to the gimbal assembly 104 and is configured to receive an input force from a user. The user interface 102 may be implemented according to any one of numerous configurations. In the depicted embodiment, however, it is implemented as a grip, or control stick, that is preferably dimensioned to be grasped by a hand.

The gimbal assembly 104 is mounted within a housing assembly 110 and is configured to allow the user interface 102 to be moved from a null position 109, which is the position depicted in FIG. 1, to a plurality of control positions in a plurality of directions. More specifically, the gimbal assembly 104, in response to an input force supplied to the user interface 102, allows the user interface 102 to be moved from the null position 109 to a plurality of control positions, about two perpendicular rotational axes—a first rotational axis 111 and a second rotational axis 113. It will be appreciated that if the human-machine interface assembly 100 is implemented as an aircraft flight control human-machine interface, such as a pilot (or co-pilot) inceptor, then the first and second rotational axes 111, 113 may be referred to as the roll axis and the pitch axis, respectively.

No matter its specific end use, the gimbal assembly 104 includes, among various other components, a first shaft (or shafts) 122 and a second shaft 124 that are each rotationally mounted in the housing assembly 110. The first shaft(s) 122 is (are) rotationally mounted along the first rotational axis 111, and the second shaft 124 is rotationally mounted along the second rotational axis 113. The gimbal assembly 104, via the first and second shafts 122, 124, and its various other components, allows the user interface 102 to be movable about the first rotational axis 111 in a port direction 112 and a starboard direction 114, and about the second axis 113 in a forward direction 116 and an aft direction 118. It will additionally be appreciated that the gimbal assembly 104 is configured to allow the user interface 102 to be simultaneously rotated about the first and second rotational axes 111, 113 to move the user interface 102 in a combined forward-port direction, a combined forward-starboard direction, a combined aft-port direction, or a combined aft-starboard direction, and back to or through the null position 109. A detailed description of the gimbal assembly 104 is not needed to fully enable or describe the invention, and will thus not be provided.

Before proceeding further, it is noted that the human-machine interface assembly 100 may be implemented as either an active system or a passive system. If implemented as an active system, the assembly 100 may further include one or more non-illustrated motors to actively supply force feedback to the user interface 102. If implemented as a passive system, it will be appreciated that the assembly 100 would not include any motors. In either instance, however, the assembly 100 would preferably include the spring return-to-null assemblies 106. In the case of the active system, the motors would be the primary means of supplying feedback force to the user interfaces 102, with the spring return-to-null assemblies 106 being the back-up feedback force source. It will nonetheless be appreciated that in the remainder of the description, the assembly 100 is described as if it were implemented as a fully passive system.

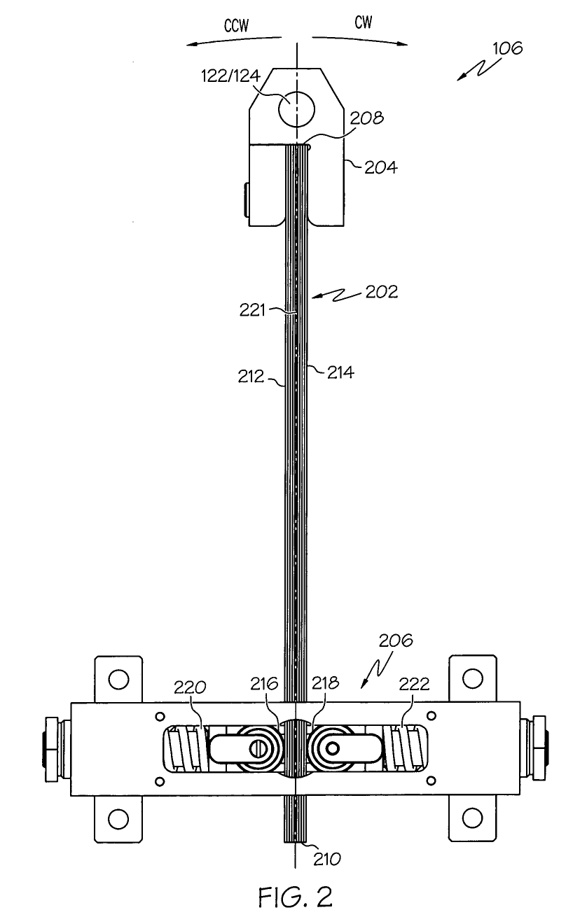

The spring return-to-null assemblies 106, which in the depicted embodiment each include a first spring return-to-null assembly 106-1 and a second spring return-to-null assembly 106-2, are mounted on the housing assembly 110 and are used to supply force feedback to the user interface 102 when the user interface 102 is moved from the null position 109. The first spring return-to-null assembly 106-1 is configured to supply force feedback to the user interface 102 in opposition to user interface displacements having a vector component in either the forward or backward direction 116, 118. The second spring return-to-null assembly 106-2 is configured to supply force feedback to the user interface 102 in opposition to user interface displacements having a vector component in either the port or starboard direction 112, 114. The spring return-to-null assemblies 106 are also configured such that the force feedback each supplies is adjustable, depending on the direction in which the user interface 102 is moved. That is, the spring return-to-null assemblies 106 may be adjusted such that the feedback force it supplies to the user interface 102 differs, depending on the direction in which the user interface is moved. For example, when the user interface 102 is moved in the port direction 112, the first spring return to null assembly 106-1 may supply feedback force magnitudes that are unequal to the feedback force magnitudes it supplies (for a given displacement magnitude) when the user interface 102 is moved in the starboard direction 114. Similarly, when the user interface 102 is moved in the forward direction 116, the second spring return to null assembly 106-1 may supply feedback force magnitudes that are unequal to the feedback force magnitudes it supplies (for a given displacement magnitude) when the user interface 102 is moved in the aft direction 118. A particular preferred embodiment of one the spring return-to-null assemblies 106 is depicted in FIG. 2, and with reference thereto will now be described in greater detail.

The spring return-to-null assemblies 106 each include a spring 202, a clamp 204, and a pivot assembly 206. The spring 202 is implemented as a cantilever spring, and thus includes a fixed end 208 and a free end 210, and additionally includes a first side 212 and an opposing second side 214. The cantilever spring fixed end 208 is coupled to the shaft 122 (124) via the clamp 204 and thus rotates whenever the shaft 122 (124) is rotated. The cantilever spring free end 210 is disposed between first and second contacts 216, 218 in the pivot assembly 206, which is described in greater detail further below. As will also be described in greater detail below, the first and second contacts 216, 218 are configured such that the cantilever spring 202 is free to move axially between the first and second contacts 216, 218 whenever the cantilever spring free end 208 is rotated. It will thus be appreciated that the cantilever spring 202, via the free end 210, supplies a torque to the shaft 122 (124), whenever the user interface 102, and thus the shaft 122 (124), is rotated out of the null position 109, that urges the shaft 122 (124) toward the null position.

Briefly returning to FIG. 1, it is seen that in the depicted embodiment one or more strain gages 126 are also mounted on the cantilever spring 202. The strain gages 126 may be mounted on one or both cantilever springs 202, and on either or both of the cantilever spring first side 212 or second side 214. Preferably, however, strain gages 126 are mounted on both of the cantilever springs 202 and on both sides 212, 214 of each cantilever spring 202. No matter the number and location of the strain gages, these devices are preferably coupled to supply appropriate signals to a non-illustrated circuit or controller for health monitoring, primary or secondary position sensing, or both.

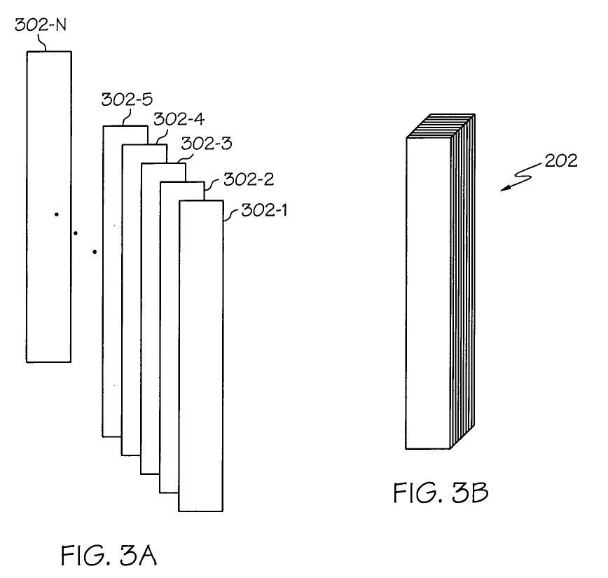

The cantilever spring 202 may be variously implemented; however, and with reference now to FIG. 3, it is seen that the cantilever spring 202 is preferably implemented using a plurality of individual cantilever springs 302 (e.g., 302-1, 302-2, 302-3, . . . 302-N). The individual cantilever springs 302 are stacked in a parallel arrangement of additive springs. Each of the individual cantilever springs 302 are also in sliding contact with each adjacent individual cantilever spring 302, effectively creating slip planes between adjacent individual cantilever springs 302. This configuration reduces the relatively high stresses that are generally associated with this type of spring. It will be appreciated that the number of individual cantilever springs 302 that are used to implement the cantilever spring 202 may vary. In one particular embodiment, the cantilever spring 202 used to implement the first return-to-null assembly 106-1 includes 13 number of individual cantilever springs 302, and the cantilever spring 202 used to implement the second return-to-null assembly 106-2 includes 11 number of individual cantilever springs 302.

Returning now to FIG. 2, the pivot assembly 206, as was previously noted, includes two contacts—a first contact 216 and a second contact 218. The pivot assembly additionally includes two load springs—a first load spring 220 and a second load spring 222. The first load spring 220 is configured to supply a first force to the first contact 216 that urges the first contact 216 into engagement with the cantilever spring first side 212, and the second load spring 222 is configured to supply a second force to the second contact 218 that urges the second contact 218 into engagement with the cantilever spring second side 214. The pivot assembly 206 may be variously disposed, but is preferably disposed at a location that is closer to the cantilever spring free end 210 than the cantilever spring fixed end 208. In the depicted embodiment, the pivot assembly 206 is disposed substantially adjacent to the cantilever bean free end 210.

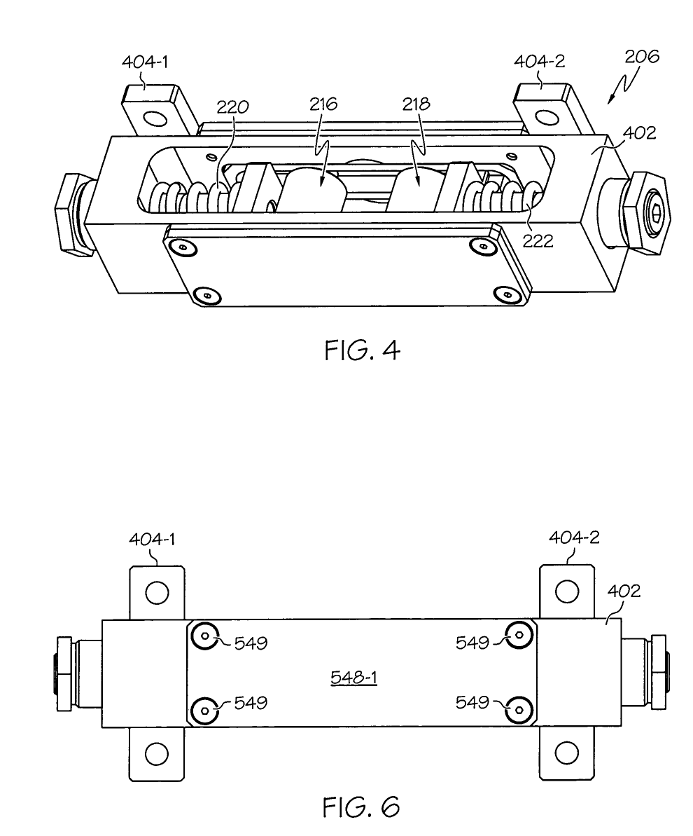

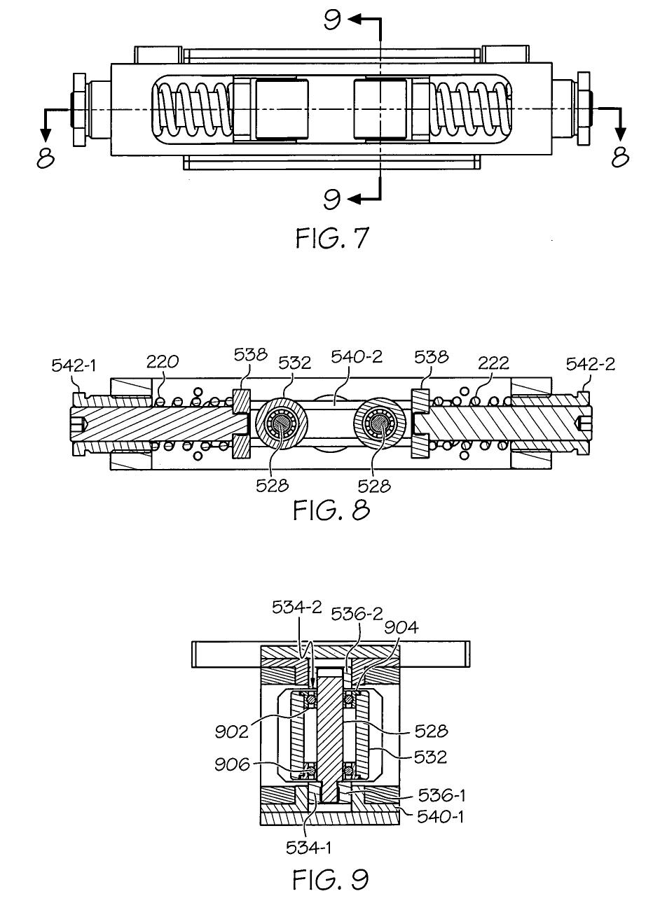

The pivot assembly first and second contacts 216, 218, in addition to being spring loaded toward the cantilever spring 202, are also configured to rotate relative to the cantilever spring 202. The first and second load springs 220, 222 preferably supply equivalent (or at least substantially equivalent) force magnitudes to the respective contacts 216, 218. Moreover, the first and second forces are preferably of magnitudes sufficient to allow the cantilever spring 202 to move freely, while maintaining contact with the first and second contacts 216, 218 throughout the range of operation. The pivot assembly 206 may be disposed such that the cantilever spring 202 exhibits equal (or at least substantially equal) spring rates no matter the direction (e.g., clockwise or counterclockwise) in which the shaft 122 (124) is rotated, or it may be mounted such that the cantilever spring 202 exhibits dual spring rates, depending on the direction in which the shaft 122 (124) is rotated. It will be appreciated that the pivot assembly 206 may be variously configured and implemented. However, a particular preferred implementation of the pivot assembly 206 is depicted in FIGS. 4-9, and before further describing the spring return-to-null assembly 106 will be described in greater detail.

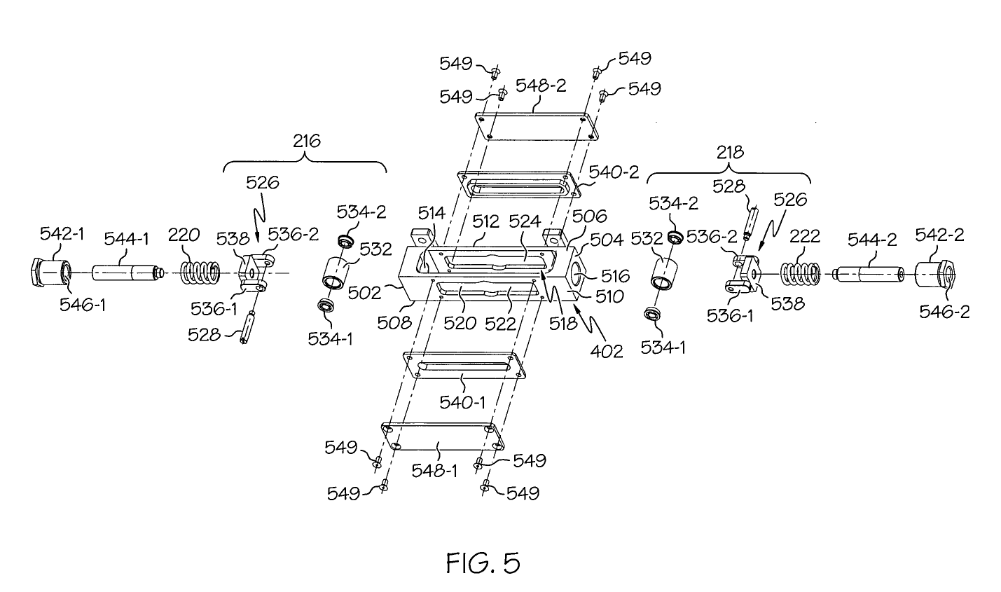

Referring first to FIG. 4, the pivot assembly 206 includes a frame 402, within which the first and second contacts 216, 218 and first and second load springs 220, 222 are disposed. The frame 402, as depicted most clearly in FIG. 5, includes a first end 502, a second end 504, a top surface 506, a bottom surface 508, a front surface 510, and a rear surface 512. The first and second ends 502 and 504 include symmetrically disposed openings 514 and 516, respectively, the top and bottom surfaces 506 and 508 include symmetrically disposed openings 518 and 520, respectively, and the front and rear surfaces 510 and 512 include symmetrically disposed openings 522 and 524, respectively.

With continued reference to FIG. 5, and with reference also to FIGS. 6-9, it is seen that the first and second contacts 216, 218 each include a bracket 526, a roller shaft 528, a roller 532, and a plurality of bearings 534 (e.g., 534-1, 534-2). The bracket 502 includes two guides 536 (e.g., 536-1, 536-2) and an end plate 538. The guides 536-1 and 536-2 extend through the symmetric openings 522 and 524, respectively, and into first and second guides 540-1 and 540-2, respectively. The first and second guides 540-1 and 540-2 are coupled to the frame front and rear surfaces 510 and 512, respectively, and are preferably formed of a low friction material, such as polytetrafluoroethylene, or other suitable material. The guides 540 prevent the brackets 526 from rotating while providing relatively low friction interfaces for relatively rapid axial bracket 526 movements.

The roller shafts 528 are each coupled to one of the brackets 526, via suitable openings in the bracket guides 536, and the rollers 532 are each rotationally mounted on one of the roller shafts 528 via the plurality of bearings 534. In particular, as is shown most clearly in FIG. 9, each bearing includes an inner race 902, which is mounted on one of the roller shafts 528, an outer race 904, on which one of the rollers 532 is mounted, and a plurality of bearing balls 906 disposed between the inner 902 and outer 904 races. With this configuration the rollers 532 are thus rotatable about the roller shafts 528.

Returning once again to FIG. 5, and referring also to FIG. 8, it is seen that the pivot assembly further includes a pair of spring nuts 542 (e.g., 542-1, 542-2) and a pair of roller guides 544 (e.g., 544-1, 544-2). The spring nuts 542-1 and 542-2 extend through the openings 514 and 516, respectively, and are retained therein via, for example, suitable mating threads. The roller guides 544-1 and 544-2 extend through openings 546-1 and 546-2, respectively, formed through the spring nuts 542, and are coupled to one of the brackets 526. More specifically, each roller guide 544 is coupled to one of the bracket end plates 538 via, for example, suitably threaded openings formed therein. The roller guides 544-1 and 544-2 additionally extend through the first load spring 220 and the second load spring 222, respectively. As FIG. 8 also shows most clearly, the first load spring 220 and the second load springs 222 also engage the first spring nut 542-1 and the second spring nut 542-2, respectively. It may thus be appreciated that the first spring nut 542-1 and the second spring nut 542-2 are preferably used to adjust the spring force supplied from the first load spring 220 and the second load spring 222, respectively, to the first contact 216 and the second contact 218, respectively. As noted previously, the first and second load springs 220, 222 are preferably adjusted to supply equivalent (or at least substantially equivalent) spring force magnitudes to the first and second contacts 216, 218, respectively.

Referring now to FIG. 6 in combination with FIG. 5, the pivot assembly 106 also preferably includes a pair of cover plates 548 (e.g., 548-1, 548-2). The cover plates 548-1 and 548-2 are coupled to the frame front surface 510 and rear surface 512, respectively, via suitable fasteners 549. The cover plates 548-1 and 548-2, when installed, cover the openings 522 and 542, respectively, and also retain the first guide 540-1 and the second guide 540-2 in place. As FIGS. 4-6 also depict, the frame 402 additionally includes a plurality of mount posts 404 (e.g., 404-1, 404-2). The mount posts 404 are used to mount the pivot assembly 106 to, for example, the housing 110 assembly of FIG. 1, via suitable non-illustrated fasteners. As will be described in more detail further below, the housing assembly 110 is preferably configured such that the pivot assembly 206 may be mounted thereto at a plurality angles relative to the spring 202.

Returning once again to FIG. 2, the pivot assembly 206 is shown mounted such that the spring return-to-null assembly 106 exhibits equal (or at least substantially equal) spring rates no matter the direction (e.g., clockwise or counterclockwise) in which the shaft 122 (124) is rotated. More specifically, the pivot assembly 206 is mounted substantially perpendicular to an axis 221 that extends through the cantilever spring 202 between the cantilever spring fixed end 208 and the free end 210. With the pivot assembly 206 thusly mounted, when the shaft 122 (124) is in the null position 109 the first and second contacts 216, 218 (e.g., the rollers 532) engage the cantilever spring first and second sides 212, 214, respectively, at equal (or at least substantially equal) distances from the cantilever spring fixed end 208.

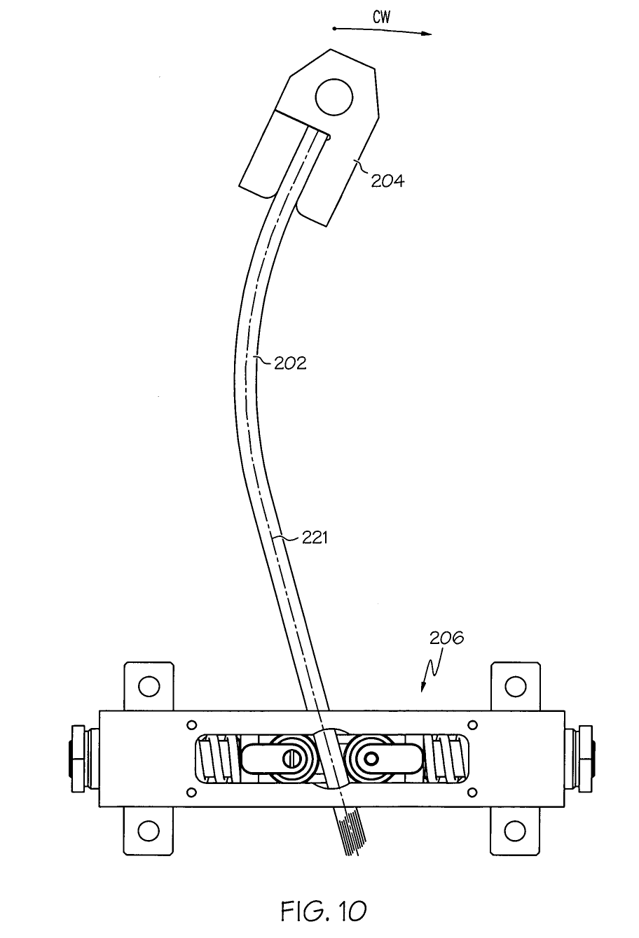

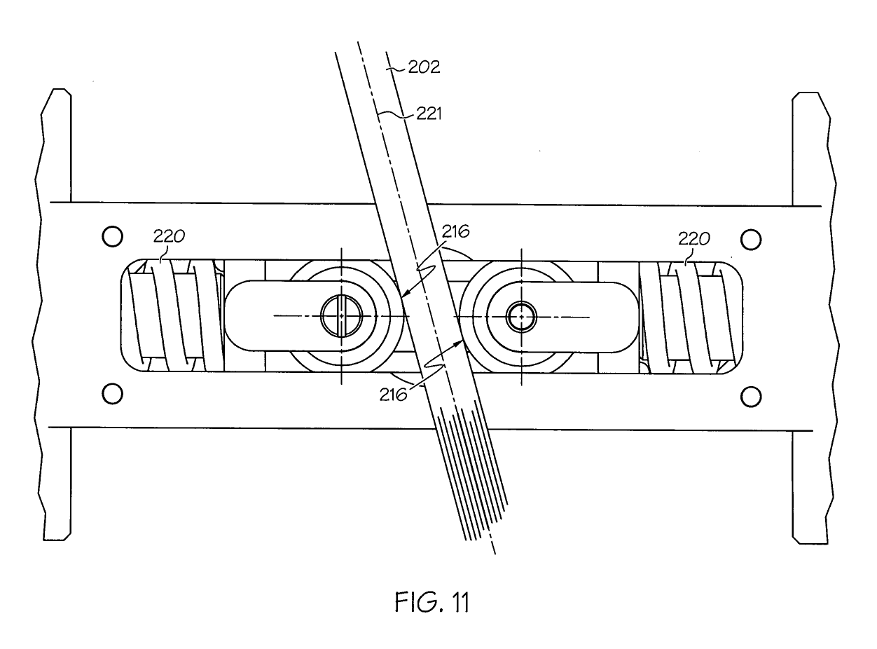

Turning now to FIGS. 10 and 11, operation of the spring return-to-null assembly 106 will be described when the pivot assembly 206 is mounted as depicted in FIG. 2, and the shaft 122 (124) is rotated. When the shaft 122 (124) is rotated out of the null position 109, the cantilever spring fixed end 208, via the clamp 204, is also rotated. The cantilever spring 202, as noted above, is free to move axially between the first and second contacts 216, 218 whenever the cantilever spring free end 208 is rotated. Moreover, and as FIG. 11 shows most clearly, the cantilever spring 202, upon rotation of the cantilever spring fixed end 208, reacts against the first and second contacts 216, 218, axially displacing the first and second contacts 216, 218 (illustrated via the double-headed arrow in FIG. 11) and compressing the first and second load springs 220, 222. The compression of the first and second load springs 220, 222 produces a counter-force on the cantilever spring 202. As the rotation of the shaft 122 (124) increases this counter-force increases and simulates a spring with a constant (or at least substantially constant) force output. It is noted that although the operation of the spring return-to-null assembly 106 is depicted and described for shaft rotations in the clockwise direction (as viewed in FIG. 10), operation of the spring return-to-null assembly 106 would be substantially identical for shaft rotations in the counterclockwise direction.

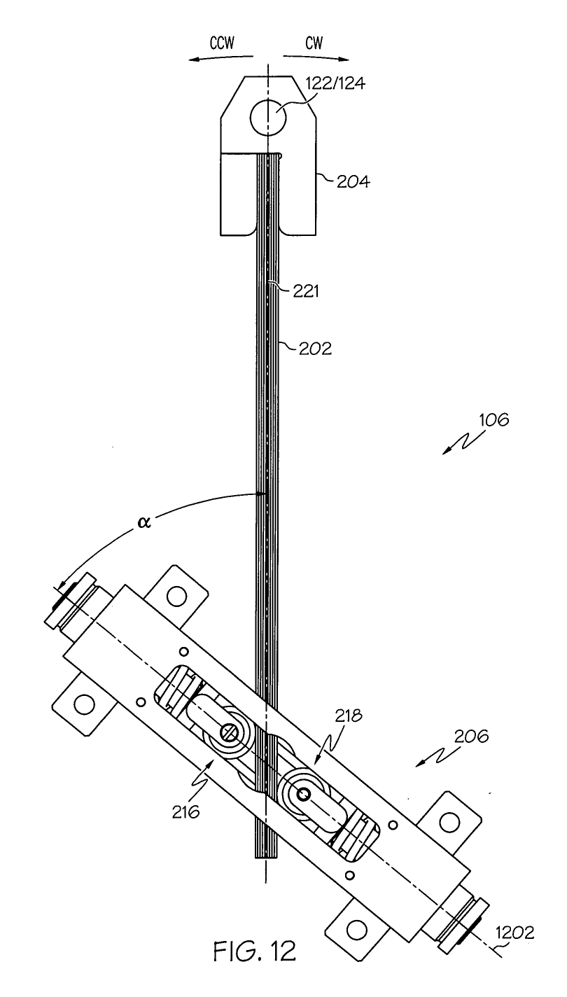

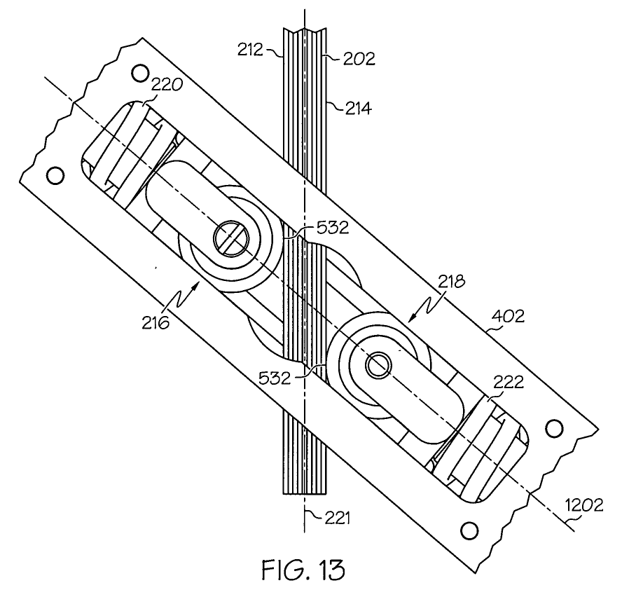

With reference now to FIG. 12, operation of the spring return-to-null assembly 106 will be described when the pivot assembly 206 is mounted such that the cantilever spring 202 exhibits dual spring rates. More specifically, the pivot assembly 206 is mounted such that an axis of symmetry 1202 that extends through the pivot assembly 206 between the first and second ends 502, 504 of the frame 402 is disposed at an angle (α) relative to the above-mentioned axis 221 that extends through the cantilever spring 202. It will be appreciated that the angle (α) may vary, and may be selected to implement the desired different spring rates. When the pivot assembly 206 is thusly mounted, as shown most clearly in FIG. 13, when the shaft 122 (124) is in the null position 109 the first and second contacts 216, 218 (e.g., the rollers 532) engage the cantilever spring first and second sides 212, 214, respectively, at unequal distances from the cantilever spring fixed end 208. In the depicted embodiment, the first contact 216 engages the cantilever spring first side 212 at a location that is closer to the cantilever spring fixed end 208 than the location at which the second contact 218 engages the cantilever spring second side 214.

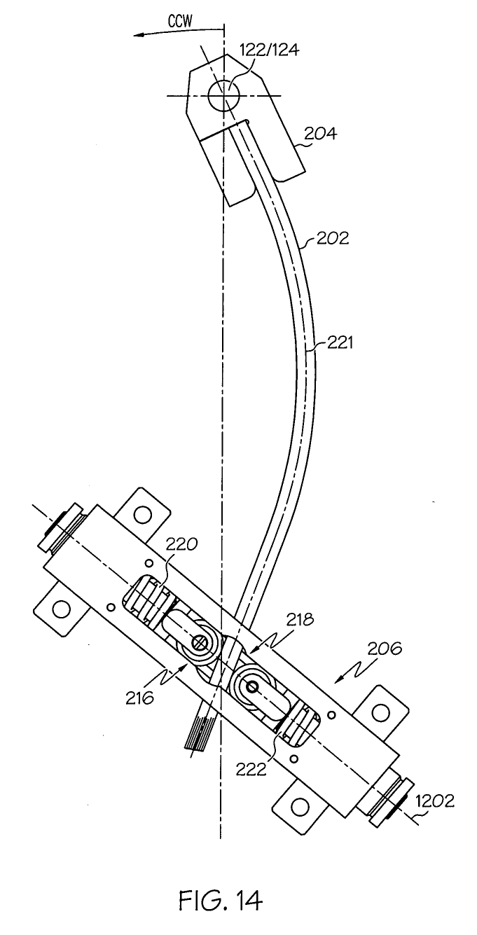

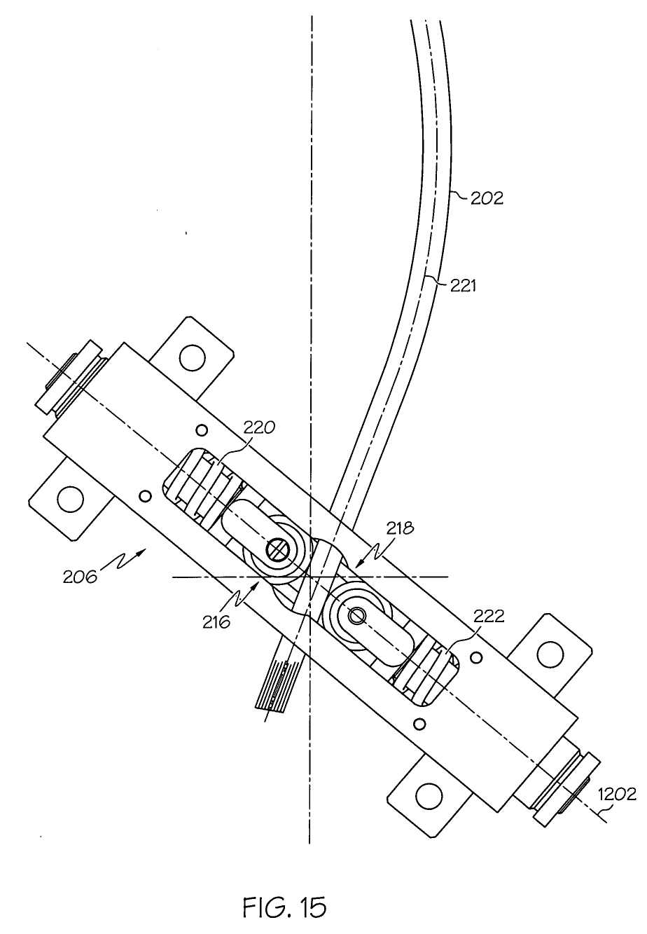

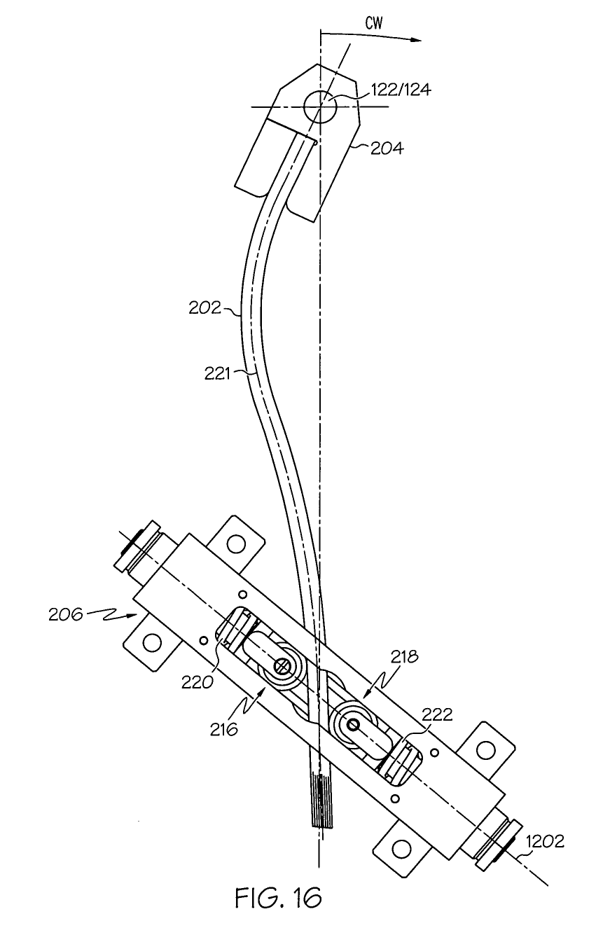

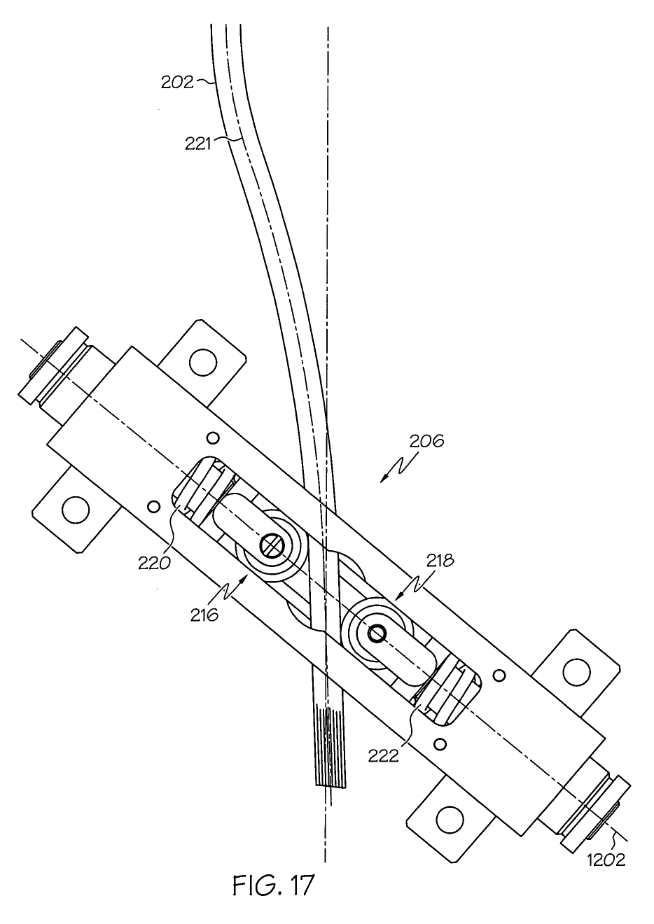

Operation of the spring return-to-null assembly 106 when the pivot assembly 206 is mounted as depicted in FIGS. 12 and 13, and when the shaft 122 (124) is rotated out of the null position 109, is depicted in FIGS. 14-17. As described before, when the shaft 122 (124) is rotated out of the null position 109, the cantilever spring fixed end 208, via the clamp 204, is also rotated, and the cantilever spring 202 reacts against the first and second contacts 216, 218, axially displacing the first and second contacts 216, 218 and compressing the first and second load springs 220, 222. As was also described previously, the compression of the first and second load springs 220, 222 produces a counter-force on the cantilever spring 202 that increases as shaft rotation in the same direction increases. However, because of the different contact 216, 218 locations, the spring rate exhibited by the cantilever spring 202, and thus the torque it supplies to the shaft 122 (124), differs depending upon whether the shaft 122 (124) is rotated in the counterclockwise direction (FIGS. 14 & 15) or the clockwise direction (FIGS. 16 & 17). With the configuration depicted in FIG. 12, the compression spring 202 will exhibit a relatively higher spring rate when the shaft 122 (124) is rotated in the counterclockwise direction, than when the shaft 122 (124) is rotated in the clockwise direction.

The spring return-to-null assembly 106, in addition to being configurable to exhibit either equal or dual spring rates, also maintains smooth motion, by virtue of the continuous engagement between the first and second contacts 216, 218 and the cantilever spring 202, throughout the full rotational range(s) of the shaft(s) 122 (124). As a result, a crossover “click” is not exhibited when the shaft 122 (124) is rotated through the null position. The spring return-to-null assembly 106 also does not exhibit the non-linear effect that is typically associated with cantilever springs with a fixed pivot point. Moreover, when strain gages are included on the compression spring(s) 202, position and health monitoring functions can be implemented.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention. It being understood that various changes may be made in the function and arrangement of elements described in an exemplary embodiment without departing from the scope of the invention as set forth in the appended claims.

What is claimed is:

1. A spring-return-to-null assembly, comprising:
a cantilever spring including a fixed end, a free end, and opposing first and second sides, the cantilever spring fixed end adapted to be coupled to a shaft and configured to supply a torque to the shaft at least when a torque is supplied to the cantilever spring fixed end; and
a pivot assembly engaging the cantilever spring at a location that is closer to the cantilever spring free end than the cantilever spring fixed end, the pivot assembly including:
a first contact engaging the cantilever spring first side,
a second contact engaging the cantilever spring second side,
a first load spring supplying a force to the first contact that urges the first contact into engagement with the cantilever spring first side, and
a second load spring supplying a force to the second contact that urges the second contact into engagement with the cantilever spring second side.

2. The assembly of claim 1, further comprising:
a clamp coupled to the cantilever spring fixed end and adapted to be coupled to the shaft.

3. The assembly of claim 1, wherein the first and second contacts each comprise a rotationally mounted roller that is rotatable relative to the cantilever spring.

4. The assembly of claim 1, wherein the cantilever spring, upon application of the torque to the cantilever spring fixed end, displaces the first and second contacts in opposing axial directions, to thereby compress the first and second load springs.

5. The assembly of claim 1, wherein:
the pivot assembly further comprises a frame;
the first contact, the second contact, the first load spring, and the second load spring are each disposed within the frame; and
the cantilever spring extends through the frame.

6. The assembly of claim 5, wherein the first and second contacts each comprise:
a bracket movably disposed within the frame;
a roller shaft coupled to the bracket;
a roller surrounding at least a portion of the roller shaft; and
a plurality of bearings, each bearing including an inner race and an outer race, each of the inner races mounted on the roller shaft, the roller mounted on each of the outer races.

7. The assembly of claim 6, wherein:
the frame includes a first end, a second end, a top surface, a bottom surface, a front surface, and a rear surface, symmetric first openings in the first and second ends, symmetric second openings in the top and bottom surfaces, and symmetric third openings in the front and rear surfaces;
the cantilever spring extends through the symmetric second openings; and
portions of each bracket assembly extend through the symmetric third openings.

8. The assembly of claim 7, further comprising:
a first spring nut extending through one of the first openings;
a second spring nut extending through another of the first openings;
a first roller guide coupled between the first spring nut and one of the rollers;
a second roller guide coupled between the second spring nut and another of the rollers.

9. The assembly of claim 8, wherein:
the first load spring surrounds the first roller guide and engages the first roller nut and one of the rollers; and
the second load spring surrounds the second roller guide and engages the second roller nut and another one of the rollers.

10. The assembly of claim 1, wherein:
the first contact point engages the cantilever spring first side at a location on the cantilever spring first side that is a first distance from the cantilever spring fixed end;
the second contact point engages the cantilever spring second side at a location on the cantilever spring second side that is a second distance from the cantilever spring fixed end; and
the first and second distances are adjustable.

11. The assembly of claim 10, wherein:
the shaft is configured to rotate about a first rotational axis; and
the first and second distances are adjusted by rotating the pivot assembly about a second rotational axis that is parallel to the first rotational axis.

12. A return-to-null assembly, comprising:
a shaft configured to rotate from a null position to a plurality of control positions;
a cantilever spring including a fixed end, a free end, and opposing first and second sides, the cantilever spring fixed end coupled to the shaft and configured to supply a torque to the shaft, at least when the shaft is rotated from the null position, that urges the shaft toward the null position;
a pivot assembly engaging the cantilever spring at a location that is closer to the cantilever spring free end than the cantilever spring fixed end, the pivot assembly comprising:
a first contact engaging the cantilever spring first side,
a second contact engaging the cantilever spring second side,
a first load spring supplying a first force to the first contact that urges the first contact into engagement with the cantilever spring first side, and
a second load spring supplying a second force to the second contact that urges the second contact into engagement with the cantilever spring second side.

13. A spring pivot assembly, comprising:
a frame; and
a pair of spring-loaded roller assemblies movably disposed within the frame, each spring-loaded roller assembly comprising:
a bracket movably disposed within the frame;
a roller shaft coupled to the bracket;
a roller surrounding at least a portion of the roller shaft;
a plurality of bearings, each bearing including an inner race and an outer race, each of the inner races mounted on the roller shaft, the roller mounted on each of the outer races; and
a load spring disposed between the frame and the bracket.

14. The assembly of claim 13, wherein:
the frame includes a first end, a second end, a top surface, a bottom surface, a front surface, and a rear surface, symmetric first openings in the first and second ends, symmetric second openings in the top and bottom surfaces, and symmetric third openings in the front and rear surfaces; and
portions of each bracket assembly extend through the symmetric third openings.

15. The assembly of claim 14, further comprising:
a first spring nut extending through one of the first openings;
a second spring nut extending through another of the first openings;
a first roller guide coupled between the first spring nut and a first one of the pair of rollers assemblies;
a second roller guide coupled between the second spring nut and a second one of the pair of roller assemblies.

16. The assembly of claim 15, wherein:
each load spring surrounds one of the roller guides and engages one of the spring nuts and one of the rollers.

17. A hand controller assembly, comprising:
a user interface configured to rotate from a null position to a plurality of control positions;
a cantilever spring assembly coupled to the user interface and configured to supply a force to the user interface, at least when the user interface is rotated from the null position, that urges the user interface toward the null position,
wherein the cantilever spring assembly comprises a plurality of individual cantilever springs stacked in parallel, each individual cantilever spring in sliding contact with at least one other individual cantilever spring, each individual cantilever spring including a fixed end and a free end, the fixed end of each individual cantilever spring coupled to the user interface.

18. The assembly of claim 17, wherein:
the cantilever spring assembly is coupled to the gimbal assembly and is configured to supply a force to the gimbal assembly at least at least when the gimbal assembly rotates about the first rotational axis; and
the hand controller assembly further comprises a second cantilever spring assembly coupled to the gimbal assembly and configured to supply a force to the gimbal assembly, at least when the gimbal assembly is rotates about the second rotational axis, that urges the user interface toward the null position.

19. The assembly of claim 18, wherein the second cantilever spring assembly comprises a plurality of second individual cantilever springs stacked in parallel, each second individual cantilever spring in sliding contact with at least one other second individual cantilever spring, each second individual cantilever spring including a fixed end and a free end, the fixed end of each second individual cantilever spring coupled to the gimbal assembly.

20. The assembly of claim 17, further comprising a strain gage coupled to the cantilever spring assembly.

21. The assembly of claim 17, further comprising:
a clamp coupled to the fixed end of each individual cantilever spring and further coupled to, and configured to rotate with, the user interface.

22. The assembly of claim 17, wherein the user interface comprises:
a grip adapted to be grasped by a hand; and
a gimbal assembly coupled to the grip and configured to rotate about a first rotational axis and a second rotational axis.
